(19) United States
(12) Patent Application Publication
(10) Pub. No.: US 2026/0079496 A1
(43) Pub. Date: Mar. 19, 2026

(54) TACTILE-ADAPTIVE SNAKE ROBOT NAVIGATION SYSTEM

(71) Applicant: Northeastern University, Boston, MA (US)

(72) Inventors: Alireza Ramezani, Bridgewater, MA (US); Shuo Jiang, San Jose, CA (US); Adarsh Salagame, Boston, MA (US); Lawson L.S. Wong, Boston, MA (US)

(21) Appl. No.: 19/330,042

(22) Filed: Sep. 16, 2025

Related U.S. Application Data
(60) Provisional application No. 63/695,408, filed on Sep. 17, 2024.

(51) Int. Cl. G05D 1/435; G05D 1/229; G05D 101/15; G05D 107/20; G05D 109/10; G05D 111/50

(52) U.S. Cl. CPC G05D 1/435; G05D 1/229; G05D 2101/15; G05D 2107/20; G05D 2109/16; G05D 2111/58

(57) ABSTRACT

A method for snake robot navigation, the method including: providing a snake robot comprising a plurality of modules and a plurality of tactile sensors disposed thereon; planning a path over a terrain between an initial position and a target location; detecting a tactile datum from the plurality of tactile sensors; selecting, based on the path, one of a plurality of gaits the snake robot may perform by relative movement of the plurality of modules; dynamically adjusting the selected gait based on the tactile datum; and commanding the plurality of modules to perform the adjusted gait.

### CROSS REFERENCE TO RELATED APPLICATIONS

This application claims the benefit of priority to U.S. Provisional Application No. 63/695,408, filed on Sep. 17, 2024, the entire contents of which are hereby incorporated by reference herein.

### GOVERNMENT SUPPORT

This invention was made with government support under Grant No. CMMI-2142519 was awarded by the National Science Foundation. The government has certain rights in the invention.

### BACKGROUND OF THE DISCLOSED SUBJECT MATTER

Snake robots have garnered significant attention in the field of robotics due to their unique body structure and ability to navigate challenging environments. These robots, comprising sequentially interconnected joints, can execute distinctive motions and access narrow spaces that prove challenging for other robot types. Snake robots have shown promise in specialized scenarios such as underwater exploration and disaster response. However, controlling snake robots in complex environments with obstacles or uneven terrain presents significant challenges, as their locomotion relies on generating anisotropic friction through undulating motions across the entire body.

Recent advancements in robot skin technology have enabled the development of snake robots with body-surface tactile perception. These tactile sensors provide valuable information about terrain characteristics, including surface roughness and slope, through the robot's numerous ground contacts. However, effectively integrating this tactile information into the control loop to enhance terrain adaptability remains an open challenge. Traditional control methods often struggle to fully leverage the potential of whole-body tactile sensing for improving snake robot locomotion in complex, large-scale environments. Traditional control without utilizing tactile sensing may struggle to adapt gait without environmental information and could be prone to traversal failure by selection of an incorrect gait, such as falling during uphill climbing.

### SUMMARY OF THE DISCLOSED SUBJECT MATTER

The purpose and advantages of the disclosed subject matter will be set forth in and apparent from the description that follows, as well as learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a method for snake robot navigation, the method including: providing a snake robot comprising a plurality of modules and a plurality of tactile sensors disposed thereon; planning a path over a terrain between an initial position and a target location; detecting a tactile datum from the plurality of tactile sensors; selecting, based on the path, one of a plurality of gaits the snake robot may perform by relative movement of the plurality of modules; dynamically adjusting the selected gait based on the tactile datum; and commanding the plurality of modules to perform the adjusted gait.

In some embodiments, planning the path comprises segmenting the path over terrain into a series of contiguous waypoints between the initial position and the target location.

In some embodiments, planning the path over the terrain is performed by a high-level controller of a hierarchical reinforcement learning model.

In some embodiments, selecting the gait and dynamically adjusting the selected gait is performed by a low-level controller of the hierarchical reinforcement learning model.

In some embodiments, dynamically adjusting the selected distinct gait comprises training an adaptor to recognize a terrain feature from the tactile datum, thereby selecting an adjusted gait to traverse the at least one terrain feature along the path.

In some embodiments, detecting the tactile datum from the plurality of tactile sensors comprises detecting tactile data corresponding to a subset of the plurality of modules.

In some embodiments, the subset of the plurality of modules is a module and its two adjacent modules.

In some embodiments, commanding the plurality of modules to perform the adjusted gait comprises commanding the subset of the plurality of modules based on the tactile data from the respective modules.

In some embodiments, commanding the plurality of modules to perform the adjusted gait comprises commanding a first subset of the plurality of modules to rotate in a first plane and a second subset of the plurality of modules to rotate in a second plane.

In some embodiments, the first plane is orthogonal to the second plane.

In some embodiments, the plurality of gaits comprises sidewinding, tumbling, lateral rolling, helical rolling, c-pedal wave, crawling and undulating.

In some embodiments, the tactile datum comprises a contact pattern between the plurality of modules and the terrain.

In some embodiments, the at least one tactile datum includes a local contact pattern between a subset of the plurality of modules and the terrain and a global contact pattern between the plurality of modules and the terrain.

In some embodiments, the tactile datum comprises at least one of surface roughness and slope.

In some embodiments, planning a path between the initial position and the target location comprises performing a tree search of a plurality of possible paths between the initial position and the target location.

In some embodiments, the method further includes processing sequences of tactile sensor data to determine changes in terrain characteristics over time.

In some embodiments, dynamically adjusting the selected gait comprises adjusting the selected gait in response to the detected change in terrain characteristics.

The herein disclosed subject matter is also directed to a method for training a snake robot, the method including providing a snake robot having a plurality of modules and a plurality of tactile sensors; providing a path from a starting position to a target position for the snake robot to traverse; generating in a first phase of training, a gait library comprising a plurality of gaits executable by the plurality of modules of the snake robot to traverse the path; generating in a second phase of training, a respective adaptor for each module configured to receive a tactile datum from the plurality of tactile sensors; adjusting the gaits based on the tactile datum received by the adaptor; and commanding the plurality of modules to execute the adjusted gait.

In some embodiments, the first and second phases of training are performed by a hierarchical reinforcement learning model.

In some embodiments, the hierarchical reinforcement learning model comprises a high-level controller for global navigation and a low-level controller for local navigation.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

Furthermore, the drawings may contain text or captions that may explain certain embodiments of the present disclosure. This text is included for illustrative, non-limiting, explanatory purposes of certain embodiments detailed in the present disclosure.

FIG. 1 is a schematic representation of a snake robot in accordance with embodiments of the present disclosure.

FIG. 2 is a schematic representation of a snake robot in a terrain in accordance with embodiments of the present disclosure.

FIG. 3A is a contact pattern representing tactile data corresponding to gaits in accordance with embodiments of the present disclosure.

FIG. 3B is a contact pattern representing tactile data corresponding to gaits in accordance with embodiments of the present disclosure.

FIG. 3C is a contact pattern representing tactile data corresponding to gaits in accordance with embodiments of the present disclosure.

FIG. 3D is a contact pattern representing tactile data corresponding to gaits in accordance with embodiments of the present disclosure.

FIG. 4 is a schematic representation of a hierarchical control scheme for a snake robot showing global navigation and local navigation in accordance with embodiments of the present disclosure.

FIG. 5 is a flowchart representing a method for tactile-adaptive snake robot control in accordance with embodiments of the present disclosure.

FIG. 6 is a flowchart representing a method for tactile-adaptive snake robot training in accordance with embodiments of the present disclosure.

FIG. 7 is a representation of randomly generated curriculum terrains in accordance with embodiments of the present disclosure.

FIG. 8A is a diagram of reinforcement learning in accordance with embodiments of the present disclosure.

FIG. 8B is a top view of a diagram of reinforcement learning showing each CPG module generating a particular gait pattern for n channels to guide joint motions in accordance with embodiments of the present disclosure.

FIG. 8C is a side view of a diagram of reinforcement learning showing an adaptor for each joint to control the gait mixing factor given local tactile readings in accordance with embodiments of the present disclosure.

FIG. 9 is a schematic diagram of a distributed reinforcement learning framework in accordance with embodiments of the present disclosure.

FIG. 10 is a schematic diagram of neural network architectures in accordance with embodiments of the present disclosure.

FIG. 11 is a schematic representation of a randomly generated test domain of a terrain showing a path determined by global navigation in accordance with embodiments of the present disclosure.

FIG. 12 is a schematic representation of randomly generated terrain layouts in accordance with embodiments of the present disclosure.

FIG. 13A is a plot representing training curves for the curriculum training phase in accordance with embodiments of the present disclosure.

FIG. 13B is a plot representing training curve for the tactile-adaptation phase in accordance with embodiments of the present disclosure.

FIG. 14 is a plot representing baseline comparisons between the randomly generated terrain layouts in accordance with embodiments of the present disclosure.

FIG. 15 is a representation of centroid motion in a randomly generated terrain layout in accordance with embodiments of the present disclosure.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Further, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one” but does not exclude a plurality unless the contextual use dictates otherwise. When used herein to join a list of items, “or” denotes “at least one of the items” but does not exclude a plurality of items of the list. Finally, when used herein to join a list of items, “and” denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Reference will now be made in detail to exemplary embodiments of the disclosed subject matter, an example of which is illustrated in the accompanying drawings. The method and corresponding steps of the disclosed subject matter will be described in conjunction with the detailed description of the system.

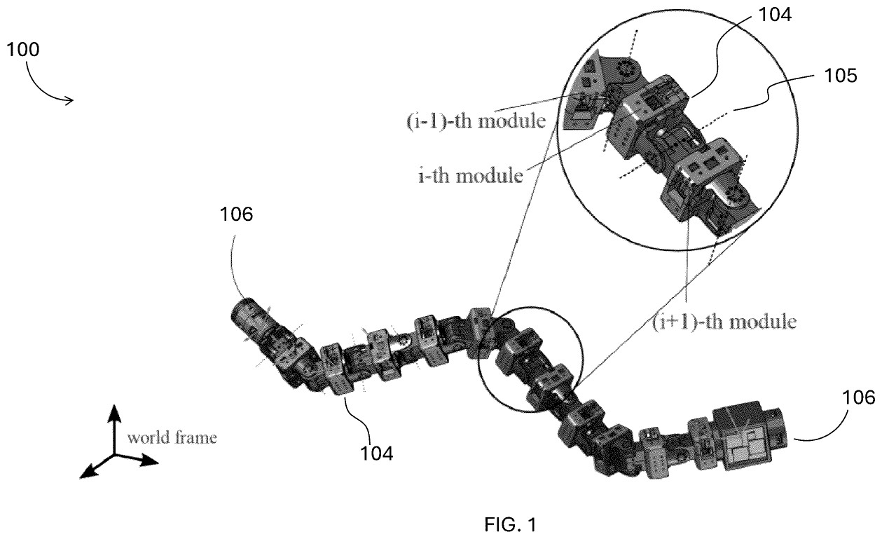

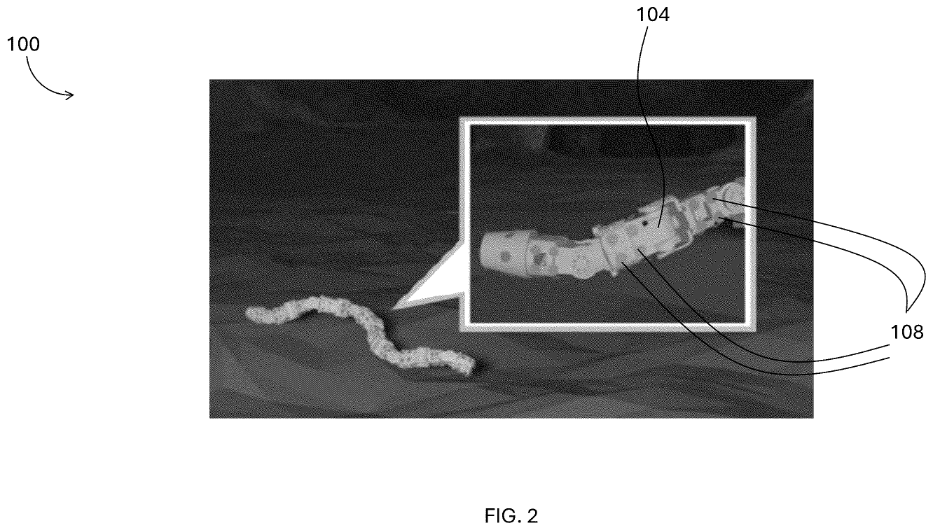

Referring now to FIG. 1, a snake robot 100 is shown according to embodiments of the present disclosure. Snake robot 100 may be any robot that emulates the body structure of snakes, having sequentially coupled and interconnected modules 104 or joints. Snake robot 100 may be configured to execute distinctive motions or gaits to traverse a terrain, such as a surface having one or more characteristics, such as the terrain shown in FIG. 2. In various embodiments, the snake robot 100 may be configured to traverse the surface of an extraplanetary body, like the earth's moon. In various embodiments, snake robot 100 may be configured to traverse underwater environments or within dangerous environments, such as disaster relief. In various embodiments, snake robot 100 may be configured to traverse a non-water fluid. Snake robot 100 may be configured to perform undulating motions to produce anisotropic friction on the contact surface for propulsion. In various embodiments, snake robot 100 may be configured to perform a plurality of distinct gaits. In various embodiments, the distinct gaits may be performed by a single module, a subset of modules or every module operating in tandem. For example, and without limitation, the distinct gaits may include sidewinding, undulating, lateral rolling, c-pedal waves, lateral rolling, crawling or the like. In various embodiments, segments of snake robot 100 may be configured to move in tandem such that segmented control of the robot can output more complex gaits. For example, and without limitation, employing different gaits in each segment may result in more complex gaits and traversal capabilities.

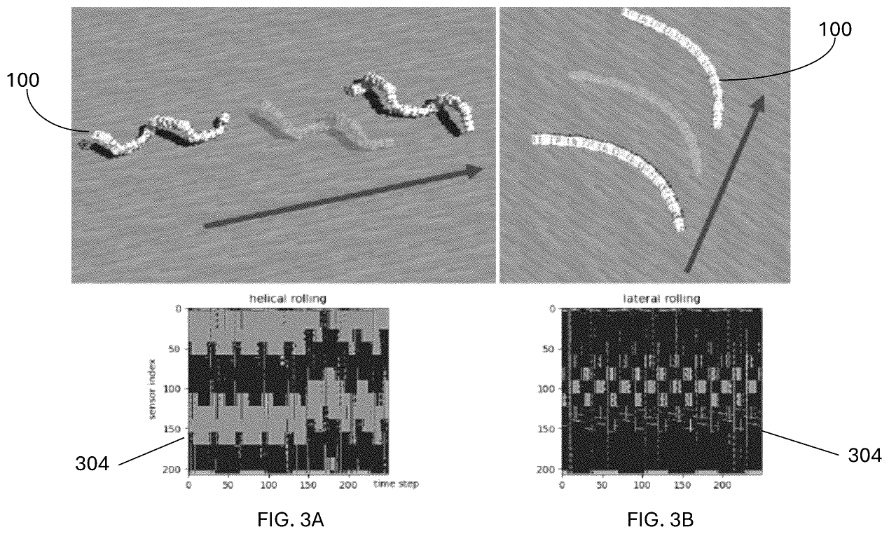

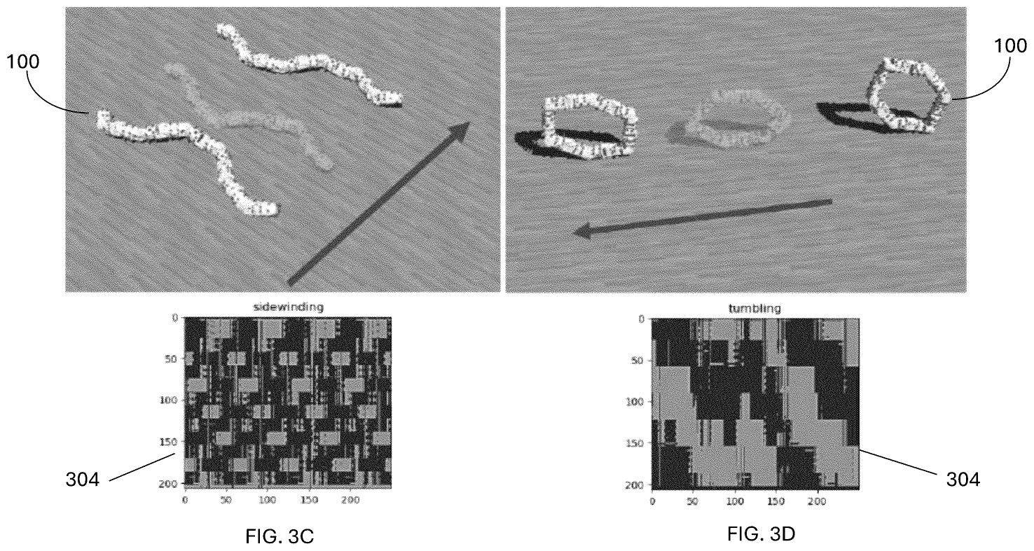

With continued reference to FIG. 1, snake robot 100 may include a plurality of tactile sensors 108 disposed throughout its body. In various embodiments, tactile sensors 108 may be cameras, body tactile sensors or another type of sensor, alone or in combination. Tactile sensors 108 may be configured to perceive precise location and force of each contact between a snake robot 100 and the terrain it is traversing. For example, and without limitation, tactile sensors 108 may be configured to perceive location and force of the entire body of snake robot 100 over the terrain. In response to the tactile sensors 108, the snake robot 100 may automatedly change its body shape to avoid damage and/or generate additional propulsion based on the determined terrain characteristics from the tactile sensors 108. In various embodiments, the plurality of tactile sensors 108 may be leveraged as a unified entity such that different gaits generate distinct contact patterns 304 as measured between the plurality of modules 104 and the terrain. Said contact patterns (as shown in FIGS. 3A-3D) encapsulate substantial information about the terrain and body movement that can be used to enhance environmental perception and motion control of snake robot 100.

With continued reference to FIG. 1, snake robot 100 may include a plurality of actuated joints or modules 104. In various embodiments, snake robot 100 may include exactly eleven modules 104. In various embodiments, snake robot 100 may include a head module 106. Head module 106 may include an onboard computing system, a radio antenna and/or an inertial measurement unit (IMU). In various embodiments, the radio antenna may be communicatively coupled to an external component, such as a lunar orbiter. The radio antenna may be configured to communicate and receive signals from said external component. In various embodiments, the IMU may be configured to precisely locate and navigate the snake robot 100. In various embodiments, onboard computing system may be configured to process measured data and generate one or more command signals in response to the IMU, tactile sensors, external signals, or the like. Snake robot 100 or a system for a snake robot may include a processor configured to receive tactile sensor data from the plurality of tactile sensors; process the tactile sensor data using a trained machine learning model to determine terrain characteristics; select a locomotion gait for the snake robot based on the determined terrain characteristics; and control actuators of the snake robot to implement the selected locomotion gait as will be described hereinbelow.

In various embodiments, trained machine learning model may be a hierarchical reinforcement learning model. The hierarchical reinforcement learning model may include a high-level controller for global navigation and a low-level controller for local navigation. The low-level controller may include a gait library containing multiple pre-trained gaits for different terrain types. The processor may be further configured to select the locomotion gait by choosing a gait from the gait library based on the determined terrain characteristics. The processor may be further configured to adjust parameters of the selected gait based on the tactile sensor data. The tactile sensors may be configured to measure normal pressure forces. The snake robot may include at least 200 tactile sensors distributed along its body. The processor may be further configured to process sequences of tactile sensor data to determine changes in terrain characteristics over time. The processor may be further configured to dynamically adjust the locomotion gait in response to detected changes in terrain characteristics.

Further, snake robot 100 may include a tail module 107. Tail module 107 may include an interchangeable payload module. For example, and without limitation, tail module 107 may include a neutron spectrometer configured to detect water ice emplaced in the interchangeable payload module. In various embodiments, tail module 107 may be entirely the interchangeable payload module, therefore in this disclosure, interchangeable payload module may be referenced as interchangeable payload module 107. For example, and without limitation, tail module 107 may include one or more other components configured to detect other phenomena or include further electronic components for navigation. For example, and without limitation, tail module 107 may be a module 104 configured to actuate similarly to the preceding modules. As described above, snake robot 100 may include a plurality of modules 104 or joint modules 104, configured to actuate about a rotational axis 105, such as a one degree-of-freedom (1-DOF) joint module. For example, and without limitation, each joint module 104 may be interplaced such that adjacent joint modules 104 rotate about orthogonal successive axes 105, therefore rotating in normal planes. Each joint module 104 may include an actuator and a power source, such as a battery. In various embodiments, each joint module 104 may include an actuator and be operatively coupled to a single or external power source, for example, a single battery may be configured to power each joint module 104 or a subset thereof.

Snake robot 100 may include a plurality of tactile sensors 108 disposed throughout its body. For example, and without limitation, snake robot 100 may include a plurality of tactile sensors 108 disposed throughout the head module 106, each joint module 104 and tail module 107. In various embodiments, the plurality of tactile sensors 108 may be disposed regularly about each module, such that each joint module 104 includes tactile sensors 108 at similar positions throughout. In various embodiments, the plurality of tactile sensors 108 may be dispersed randomly throughout the snake robot 100 or in a predetermined order, for example, a distribution known to the robot. In various embodiments, the plurality of tactile sensors 108 may be approximately 200 tactile sensors. In various embodiments, the plurality of tactile sensors 108 may be over 200 tactile sensors. The snake robot may include at least 200 tactile sensors distributed along its body. For example, and without limitation, there may be 207 tactile sensors 108 distributed over the snake robot 100. Each tactile sensor 108 may be configured to detect normal forces or normal pressure forces. In various embodiments, each tactile sensor 108 may be configured to operate at 50 Hz. In various embodiments, the plurality of tactile sensors 108 may be configured to detect terrain features on which the snake robot 100 is traversing. For example, and without limitation, the terrain features may be surface roughness, slope, ground type or the like. For example, and without limitation, the plurality of tactile sensors 108 may be configured to detect terrain features over time or the change in terrain features over time.

Referring now to FIGS. 3A-3D are representation of distinct gaits executable by the snake robot 100 and their respective tactile patterns 304. The tactile patterns 304 may be measured by the plurality of tactile sensors 108 based on normal pressure forces exerted on said tactile sensors 108 disposed on the body of snake robot 100. In various embodiments, the tactile patterns 304 may be processed utilizing computer-vision-style signal processing schemes. In various embodiments, the tactile patterns 304 may be interpreted by one or more components utilizing computer-vision. In various embodiments, the tactile patterns 304 may be incorporated into the control loop of a hierarchical reinforcement learning (HRL) control scheme to traverse complex terrains on the path planned by the high-level controller. The tactile patterns 304 may each correspond to a distinct gait performed by snake robot 100, as measured between the plurality of tactile sensors 108 and the terrain. For example, and without limitation, FIG. 3A may represent a tactile pattern 304 corresponding to helical rolling of the snake robot 100. For example, and without limitation, FIG. 3B may represent tactile pattern 304 corresponding to lateral rolling of the snake robot 100. For example, and without limitation, FIG. 3C may represent tactile patterns 304 corresponding to sidewinding of the snake robot 100. For example, and without limitation, FIG. 3D may represent tactile pattern 304 corresponding to tumbling of the snake robot 100. Other distinct gaits performed by the snake robot 100 may be determined and measured by the plurality of tactile sensors 108 when the snake robot 100 traverses differing terrains, or when another distinct gait is performed.

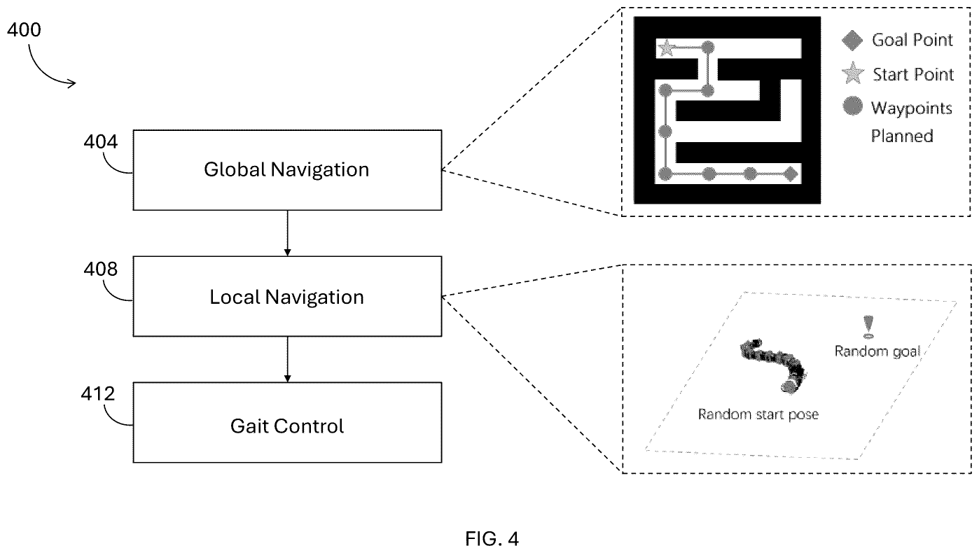

Referring now to FIG. 4, a hierarchical control scheme 400 is shown in schematic flowchart form. This system and method introduce a motion control algorithm for snake robots. Utilizing AI technology, the snake robot can sense ground information through tactile feedback and adjust its movement patterns to adapt to terrains with varying layouts and ruggedness. Hierarchical control scheme 400 may be implemented to effect navigation of snake robot 100 in complex terrains, namely, moving from any starting position to any target location on a map. The hierarchical control scheme may be implemented by trained machine learning model, which may be a hierarchical reinforcement learning model. The hierarchical reinforcement learning model may include a high-level controller for global navigation 404 and a low-level controller for local navigation 408. The low-level controller may include a gait library containing multiple pre-trained gaits for different terrain types. At the highest level of global navigation 404, a high-level controller 404 may utilized a tree search (A*) algorithm to plan efficient paths from the start point to the goal point. Further, at 404, the path may be segmented in a series of contiguous waypoints. In various embodiments, other algorithms or machine learning modules may be configured to plan paths over a terrain from a start point to a goal point. In various embodiments a plurality of paths may be planned and another algorithm or module may be configured to select a path based on certain criteria or mission information. At the local navigation level 408, a low-level controller 408 may utilize reinforcement learning (RL) to train the robot to adjust its gait to navigate from one waypoint to the next from the start point to the goal point. Tactile data perception, such as the global tactile pattern or local tactile pattern as shown in FIGS. 3A-3D, may be integrated into the RL control loop to achieve real-time terrain adaptability. At the lowest-level 412, a controller such as a PID controller or a plurality of PID controllers may be configured to actuate the modules 104 of the snake robot 100 to execute the desired gaits.

With continued reference to FIG. 4, local navigation 408 may include RL to govern the locomotion of the snake robot 100. At the local navigation level, whole-body tactile sensing information is incorporated to regulate the gait of the snake robot 100 for enhanced terrain adaptability. Local navigation 408 may include adherence to four guiding principles: individual module 104 control of the snake robot 100; using a pre-trained gait library built from curriculum learning; module (joint) gaits may depend solely on local tactile signals; and the application of centralized training and decentralized execution (CTDE) to mitigate partial observability and improve learning efficiency.

In various embodiments, a Markov Decision Process (MDP) may be implemented in part of the control scheme described herein. An MDP may be a 4-tuple M= [symbol] S, A, P, R [symbol] where S is the set of states, A is the set of actions, P(sₜ₊₁|sₜ, aₜ) is the transition probability that action a in state s at time t that will lead to state s at time t+1, R(aₜ, sₜ) is the distribution of reward when taking action aₜ in state sₜ. A policy π(aₜ|sₜ) is defined as the probability distribution of choosing action aₜ given state sₜ. The learning goal is to find a policy π* that maximizes the accumulated reward in given horizon

$$T , {π}^{*} = {arg max}_{π} \begin{matrix}E \\ {a}_{t} , {s}_{t} ∼ π\end{matrix} [ {\sum }_{t = 0}^{T - 1} {γ}^{t} \cdot R ( {a}_{t} , {s}_{t} ) ] ,$$

where γ is discount factor. RL algorithms are common choices to solve MDP problems.

Further, in various embodiments, central pattern generators (CPG) may be employed in the controls scheme described herein. CPG may be a neural circuit in the vertebrate spinal cord that generates coordinated rhythmic output signals to control snake robot 100 locomotion. By tuning its parameters, CPG can output sinusoidal waves on multiple channels. CPG-based control methods have been successfully applied to many kinds of robots, such as multi-legged robots or snake robots. Usually, to improve the terrain adaptability of CPG, optimization algorithms are often applied to adjust CPG parameters in real-time. The dynamics of CPG are shown in Equations 1-3.

$$\dot{φ} = ω + A \cdot φ + B \cdot θ \qquad ( 1 )$$

$$\ddot{r} = a \cdot [ \frac{a}{4} ( R - r ) - \dot{r} ]$$

$$x = r \cdot sin ( φ ) + δ$$

$$A = [ \begin{matrix}- {μ}_{1} & {μ}_{1} & & & \\ {μ}_{2} & - 2 {μ}_{2} & {μ}_{2} & & \\ & & ⋱ & & \\ & & {μ}_{n - 1} & - 2 {μ}_{n - 1} & {μ}_{n - 1} \\ & & & {μ}_{n} & - {μ}_{n}\end{matrix} ] \qquad ( 2 )$$

$$B = [ \begin{matrix}1 & & & & \\ - 1 & 1 & & & \\ & - 1 & ⋱ & & \\ & & ⋱ & 1 & \\ & & & - 1 & 1 \\ & & & & - 1\end{matrix} ] \qquad ( 3 )$$

φ∈ [symbol] ⁿ and r∈ [symbol] ⁿ are internal states of CPG, n is the number of output channels, typically the number of robot joints, a and μᵢ are hyperparameters that control the convergence rate. R∈ [symbol] ⁿ, ω∈ [symbol] ⁿ, θ∈ [symbol] ⁿ⁻¹, δ∈ [symbol] ⁿ are inputs that control the desired amplitude, frequency, phase shift and offset. x∈ [symbol] ⁿ is the output sinusoidal waves of n channels. In various embodiments, methodologies described herein may combine reinforcement learning (RL) with CPG to generate continuous and stable gaits, which may require only low control frequencies.

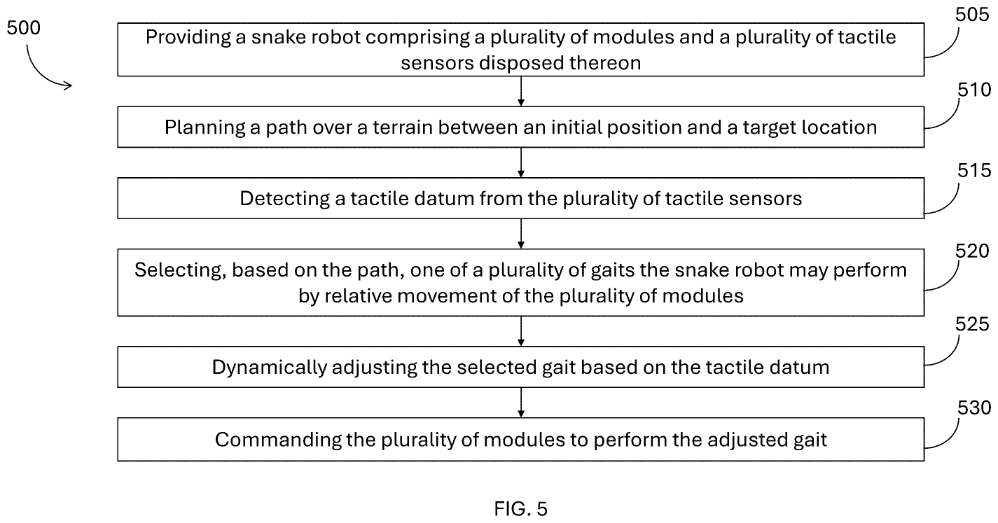

Referring now to FIG. 5, an exemplary method 500 for snake robot navigation is presented in flowchart form. Method 500, at step 505, may include providing a snake robot 100 having a plurality of modules 104 (including such modules as head module 106 and tail module 107) and a plurality of tactile sensors 108 disposed thereon. Snake robot 100 may be any described herein, having any number of modules and any number of sensors. The plurality of tactile sensors may be normal pressure sensors or any sensor configured to detect and measure tactile data, for example a contact pattern between the snake robot 100 and terrain features.

With continued reference to FIG. 5, method 500 may include, at step 510, planning a path over a terrain between an initial position and a target location. In various embodiments, the initial position may be a start point as described herein. In various embodiments, the initial position may include a start pose as described herein, the start pose may be defined by the relative position of each module 104 in the snake robot 100. In various embodiments, the initial position may be the deployment location of snake robot 100 or a predetermined start point as commanded by an external computing component or a user. In various embodiments, planning the path may be performed by a high-level controller 404 as described in reference to FIG. 4. In various embodiments, planning the path may include implementing one or more tree search (A*) algorithms to find efficient paths between start point and goal point. In various embodiments, planning the path may include segmenting the path over the terrain to a target location into contiguous waypoints between the initial position and the target location. In various embodiments, planning the path may include selecting one of a plurality of possible paths over the terrain between the start point and the goal point.

With continued reference to FIG. 5, method 500, at step 515, may include detecting a tactile datum from the plurality of tactile sensors 108. In various embodiments, tactile sensors 108 may detect the force exerted on one of the plurality of tactile sensors 108. In various embodiments, tactile sensor 108 may be configured to detect a contact pattern between the plurality of modules and the terrain. In various embodiments, the plurality of tactile sensor 108 may be configured to detect a contact pattern between the plurality of modules and the terrain. In various embodiments, the tactile data may be measured between a subset of modules 104 and the terrain features, for example, a module 104 and its two adjacent modules 104. For example, tactile data may be information about an n^{th} module 104, as well as the n^{th}−1 module 104 and the n^{th}+1 module 104 as shown in FIG. 1A. In various embodiments, detecting the tactile datum from the plurality of tactile sensors 108 includes detecting tactile data corresponding to a subset of the plurality of modules 104. In various embodiments, tactile data may include a local contact pattern between a subset of the plurality of modules 104 and the terrain. In various embodiments, the tactile data may include a global contact pattern between the plurality of modules and the terrain. In various embodiments, the tactile data may include at least one of surface roughness and slope of the terrain. In various embodiments, the tactile data may include a terrain type, such as sand, regolith, stone, gravel or the like. In various embodiments, detecting tactile data from the plurality of tactile sensors 108 may include processing sequences of tactile sensor data to determine changes in terrain characteristics over time.

With continued reference to FIG. 5, method 500 may include, at step 520, selecting, based on the path, one of a plurality of gaits the snake robot 100 may perform by relative movement of the plurality of modules 104. The plurality of gaits may constitute a gait library established by the control scheme that includes all of the gaits the robot can perform to traverse the path over the terrain. The gait library may be established by curriculum learning, as will be described hereinbelow. The gait library may be established in a first phase of learning and does not include tactile information in the training. In various embodiments, selecting the gait may include processing tactile sensor data using a trained machine learning model to determine terrain characteristics. In various embodiments, selecting a locomotion gait for the snake robot may include selecting the gait based on the determined terrain characteristics. In various embodiments, selecting the gait may be performed by a low-level controller of the hierarchical reinforcement learning model. In various embodiments, the plurality of gaits may include sidewinding tumbling, lateral rolling, helical rolling, c-pedal wave, crawling, undulating, among others. In various embodiments, selecting the path may include selecting the path based on the sequences of tactile sensor data over time.

With continued reference to FIG. 5, method 500 may include, at step 525, dynamically adjusting the selected gait based on the tactile datum to generate an adjusted gait. Dynamically adjusting the selected gait based on the tactile datum may include training an adaptor to recognize a terrain feature from the tactile datum, thereby selecting an adjusted gait to traverse the at least one terrain feature along the path. In various embodiments, the adaptor may intake localized tactile data from a module 104 and adjacent modules, recognize terrain features and subsequently select a gait output from the gait library in a one-hot manner. In various embodiments, the one or more adaptors may be a distributed neural network configured to process the full-body tactile signals, allowing snake robot 100 to perceive the current terrain and select the most suitable gait from a comprehensive gait library, thereby adjusting its movement accordingly. In various embodiments, dynamically adjusting the selected gait based on the tactile datum includes adjusting the selected gait in response to the detected change in terrain characteristics. In various embodiments, dynamically adjusting the selected gait is performed by a low-level controller of the hierarchical reinforcement learning model. In various embodiments, dynamically adjusting the selected gait may include adjusting the gait based on the sequences of tactile sensor data over time.

With continued reference to FIG. 5, method 500 may include at step 530, commanding the plurality of modules 104 to perform the adjusted gait. In various embodiments, commanding the plurality of modules 104 to perform eh adjusted gait may include commanding a subset of the plurality of modules based on the tactile data from the respective modules. In various embodiments, commanding the plurality of modules to perform the adjusted gait may include commanding a first subset of modules to rotate in a first plane and a second subset of modules to rotate in a second plane. In various embodiments, the first plane and the second plane may be orthogonal from one another. That is to say, that the first subset of modules may rotate about a first axis 105 and parallel axes and the second subset of modules to rotate about a second axis 105 and parallel axes, where the first axis is orthogonal to the second axis. The relative motion of the plurality of modules may execute the adjusted gait of the overall snake robot 100. In various embodiments, commanding the plurality of modules 104 to perform the adjusted gait may include commanding each module 104 individually to rotate such that the overall gait of the snake robot 100 is one of the distinct gaits to traverse the path over the terrain.

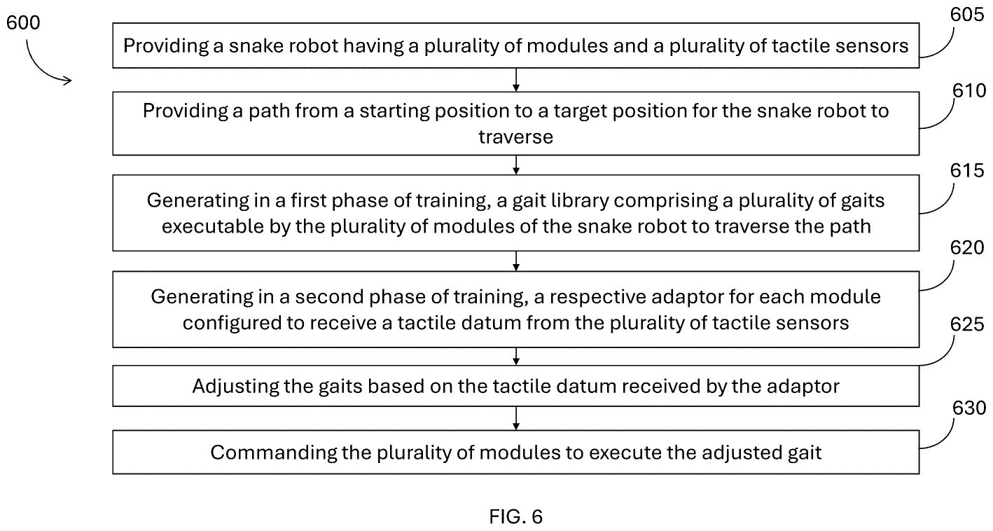

Referring now to FIG. 6, a method 600 for training a tactile-adaptive snake robot 100 is presented in flowchart form. Method 600 may include, at step 605, providing a snake robot 100 having a plurality of modules and a plurality of tactile sensors. In various embodiments, the snake robot 100 may be any as described herein, for example, a snake robot having a plurality of interconnected modules 104 as shown in FIGS. 1 and 2. In various embodiments, snake robot 100 may include a head module 106 and tail module 107. In various embodiments, snake robot 100 may include a plurality of tactile sensors 108 disposed throughout the body of the robot, including the head and/or tail module. In various embodiments, the plurality of tactile sensors 108 may be distributed evenly throughout the snake robot 100, such that a subset of tactile sensors 108 are in contact with the terrain a snake robot 100 is traversing.

With continued reference to FIG. 6, method 600 for training a tactile-adaptive snake robot 100 includes, at step 610, providing a path from a starting position to a target location for the snake robot 100 to traverse. As described above, the path may be planned by a high-level controller of a HRL by implementing a tree search. Planning the path may include segmenting the path into a series of contiguous waypoints between the starting position and the target location.

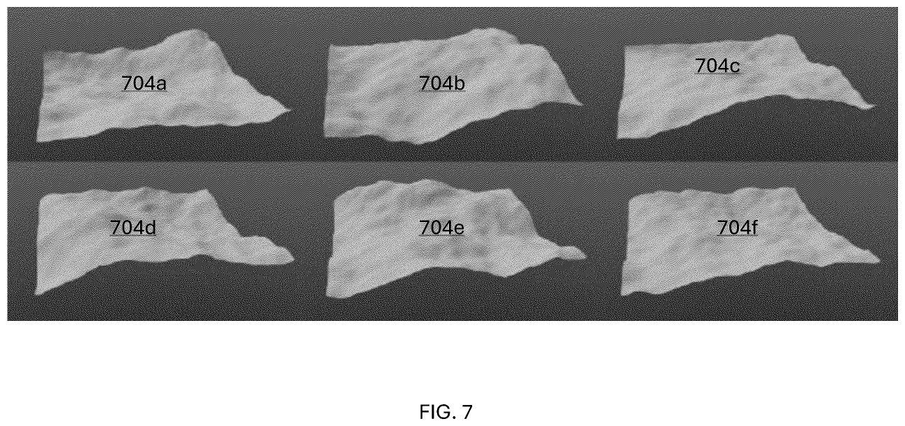

With continued reference to FIG. 6, method 600 may include at step 615, generating in a first phase of training, a gait library including a plurality of gaits executable by the plurality of modules of the snake robot to traverse the path. In various embodiments, the first phase of training may be performed by an HRL model. In various embodiments, a low-level controller of the HRL model may be configured to generate the gait library. In various embodiments, snake robots adapt distinct gaits for efficient locomotion on various terrains. For instance, sidewinding is often used on slopes, while lateral rolling may be preferable on smoother surfaces. Inspired by this, agents are trained across a spectrum of randomly generated distinctive curriculum terrains 704a-704e, as shown in FIG. 7. One of skill in the art would appreciate that any number of curriculum terrains 704n may be implemented in a first phase of training. In various embodiments, each agent may contain a CPG module, with the actor's outputs tuning the parameters of the corresponding CPG module. By CPG parameter adjustment, the agents generate optimal gaits pertinent to their curriculum terrains 704n. In various embodiments, the curriculum training terrains may be generated by Perlin noise of size 16 m×16 m, where the snake robot may learn to navigate to reach a random goal pose from any start location in each episode. In various embodiments, the MDP may be defined as:

State space: The state space includes the robot state part and tactile readings part. The robot state part consists of joint positions [symbol] ⁿ, IMU readings [symbol] ³, spatial translation between robot frame and goal pose frame [symbol] ³ and relative rotation parameterized by axis-angle system [symbol] ⁴, i.e., 21 dimensions in total. In various embodiments, only ego-centric observations from the robot may be used, so a motion capture system is not required.

Action space: The action space outputs the CPG parameters, including the desired amplitude R∈ [symbol] ⁿ, frequency ω∈ [symbol] ⁿ, phase shift θ∈ [symbol] ⁿ⁻¹ and offset δ∈ [symbol] ⁿ.

Reward: The robot is encouraged to reach the goal as soon as possible, the reward consisting of the following terms:

$${r}_{1} = \frac{1}{0.1 + {d}_{t}} \qquad ( 4 )$$

$${r}_{2} = {d}_{t - 1} - {d}_{t}$$

where dₜ is the distance between the robot frame and the waypoint frame. r₁ encourages getting closer to the goal and r₂ encourages higher velocities. r₁ and r₂ work in a complementary fashion, with r₁→0 when the robot is far away from the goal and r₂→0 when the robot is near the goal. In various embodiments a Soft Actor Critic (SAC) may be implemented as the backbone RL algorithm.

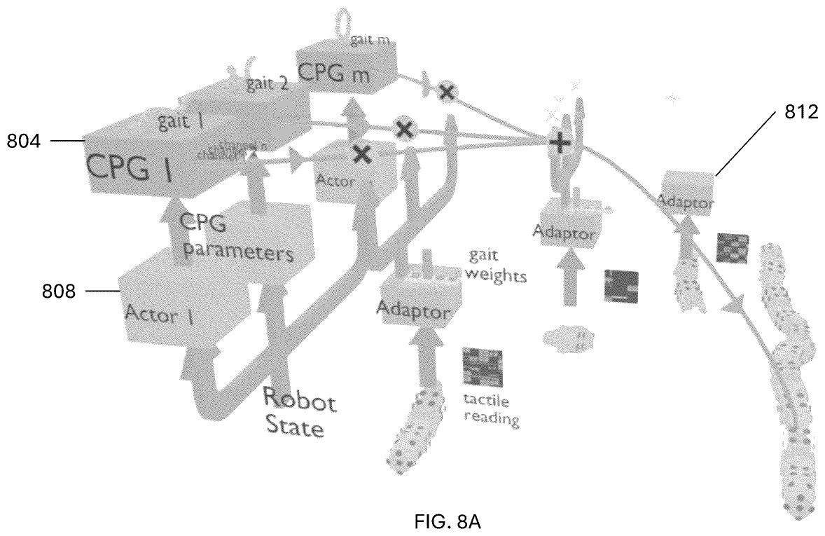

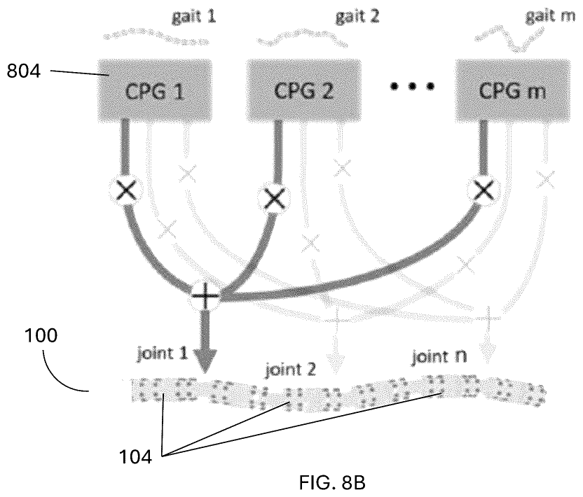

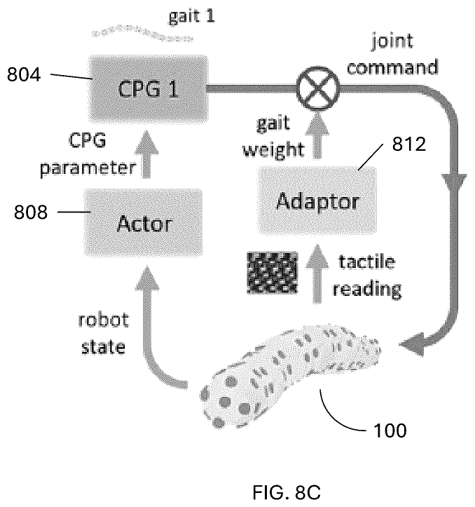

Through curriculum learning as discussed with respect to the first phase of training, a set of agents is obtained adapted to various types of terrains, achieving specific gaits by modulating the parameters of the CPG modules 804. The actors 808 of the acquired agents constitute a gait library, as illustrated by the left-hand side of FIG. 8A, represented by the yellow and green boxes. Importantly, the first phase of training does not involve tactile information. It has been shown that incorporating tactile information simply by adding it to the state space of a single agent does not yield effective terrain adaptive gaits. Thus, a second phase of training after the first phase of training is implemented as shown in FIG. 8A.

With continued reference to FIG. 6, method 600 may include, at step 620, generating, in a second phase of training a respective adaptor (812 in FIG. 8A) for each module configured to receive a tactile datum from the plurality of tactile sensors. For each module 104, or joint, an adaptor 812 is introduced which takes as input the localized tactile datum from adjacent links on the body of snake robot 100, recognizes terrain features, and subsequently selects a gait output from the gait library in a one-hot manner. SAC may be used with discrete action space to train the adaptors 812, keep the weights and biases of the actors 808 fixed during this training phase. The second phase of training may include a plurality of new terrains that were not present in the first phase of training curriculum terrains 704n to improve terrain adaptation capabilities of snake robot 100. In the second phase of training, the state space is the recent tactile readings gathered from the past one second, for example, and the action space is the one-hot gait selection signal, and the reward is unchanged. Since the basic gaits were already learned in the first phase of training to generate the gait library, there is no need to learn gaits in this second phase of training.

With continued reference to FIG. 6, method 600 at step 625, may include adjusting the gaits based on the tactile datum received by the adaptor (812 shown in FIG. 8A). In various embodiments, each CPG module 804 outputs a target joint value qᵢ∈ [symbol] ⁿ, [symbol] ∈{1, . . . m}, where in is the number of CPGs and n is the number of joints (channels) corresponding to modules 104. For each joint [symbol] ∈{1, . . . , n}, its target joint value shall be chosen as the [symbol] -th channel from one of the candidate joint values from in CPG outputs. This choice is determined by the adaptors 812 and becomes the final target joint value to execute, i.e., the adjusted gait, as shown in FIG. 8B. This formulation of localized adaptors 812 relies on the assumption that gait adjustments are locally dependent on tactile signals, with limited reliance on distant tactile signals as shown in FIG. 8C. For instance, the motion of snake robot 100 at the head module 106 may exhibit negligible correlation with the tactile feedback as measured at the tail module 107. Such framework draws inspiration from CTDE learning paradigm within the context of multi-agent reinforcement learns (MARL). In this analogy, akin to adaptors 812, each agent exclusively bases its decision-making process on a subset of the global observation, i.e., the tactile information from a subset of modules, for example, a module 104 and its adjacent modules. This configuration may eliminate the redundant inter-dependencies among agents and reduce the model dimensions without degrading performance. In various embodiments, when adaptors use a soft-max based output instead of a one-hot one, the weighted mixture of gaits from the library as the final gait did not yield effective performance. The adaptors may converge toward the average of all gaits in the library in this example, completely neglecting tactile information. In said example, introducing entropy as an additional loss term could circumvent this averaging tendency and simultaneously introduce computational instability. To overcome this, SAC with discrete action space to output a hard-max (one-hot) gait selection may be implemented.

With continued reference to FIG. 6, method 600 may include at step 630, commanding the plurality of modules 104 to execute the adjusted gait. Commanding the plurality of modules to execute the adjusted gait may include implementing a proportional-integration-derivative (PID) controller to control the actuation of each module 104 in the snake robot 100. For example, and without limitation, commanding the plurality of modules 104 may include commanding a subset of the plurality of modules 104 to execute the adjusted gait. For example, and without limitation, commanding the plurality of modules 104 may include commanding a single module to execute the adjusted gait. In various embodiments, a single PID controller may command the plurality of modules 104. In various embodiments, more than one PID controller may be configured to control the plurality of modules 104. In various embodiments, a first PID controller may control a first subset of modules 104 and a second PID controller may control a second subset of modules. In various embodiments, a plurality of PID controllers may be configured to control the plurality of modules 104, such as one controller per module, or more than one module configured to command a module such that the control scheme overlaps controllers and modules.

In various embodiments, commanding the plurality of modules 104 may include commanding an actuator of each module 104 to rotate in a single plane, i.e., about an axis of rotation 105. In various embodiments, commanding the plurality of modules 104 may include commanding a subset of modules 104 to actuate in a first direction and a second subset to actuate in a second direction to affect the adjusted gait. In various embodiments, a first subset of modules may be commanded to rotate in a first plane and a second subset of modules commanded to rotate in a second plane, the second plane orthogonal to the first. In various embodiments, commanding the plurality of modules 104 may include commanding each module 104 to rotate a certain angle about a respective axis of rotation 105. For example, and without limitation, each module 104 may be commanded to rotate a specified angle about a specified axis of rotation 105 to affect the adjusted gait. As discussed above, the adjusted gait may include sidewinding, undulating, lateral rolling, crawling, c-pedal gait, and the like by relative motion of each module 104. In various embodiments, commanding the plurality of modules 104 may include commanding the head module 106 and tail module 107 with similar or unique commands to execute the adjusted gait. For example, and without limitation, head module 106 and tail module 107 may be individually commanded separate from the plurality of modules 104 based on the mission set and hardware corresponding to those modules. For example, and without limitation, tail module 107 may be exempted from certain commands of adjusted gait to preserve onboard sensors or the like, such as the neutron spectrometer, that may be present in various embodiments.

### Distributed Learning

Due to the introduction of tactile sensors 108, simulation may become slow and not scale well to the substantial amount of experience required in the RL. Table I below illustrates exemplary operational efficiency of several commonly used robot simulators concerning various numbers of tactile sensors.

TABLE I
Real Time Factor (RTF) comparison among popular
simulators. NaN represents unstable computation.

| Number of Sensors | 0 | 50 | 100 | 150 | 200 |
|---|---|---|---|---|---|
| Gazebo | 2.28 | 0.27 | 0.09 | 0.05 | 0.02 |
| Mujoco | 110.3 | 31.79 | 24.37 | 19.92 | 12.37 |
| Webots | 42.3 | 2.31 | 1.08 | 0.69 | 0.33 |
| PyBullet | 59.4 | 49.8 | 34.8 | NaN | NaN |

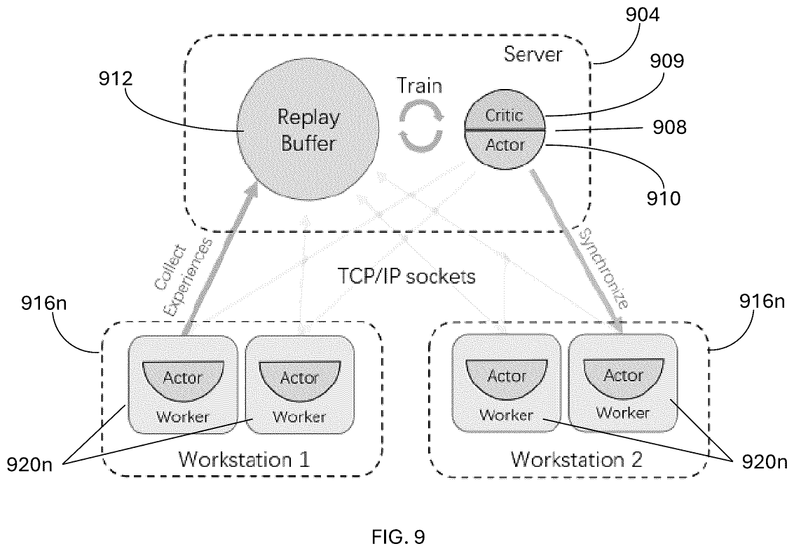

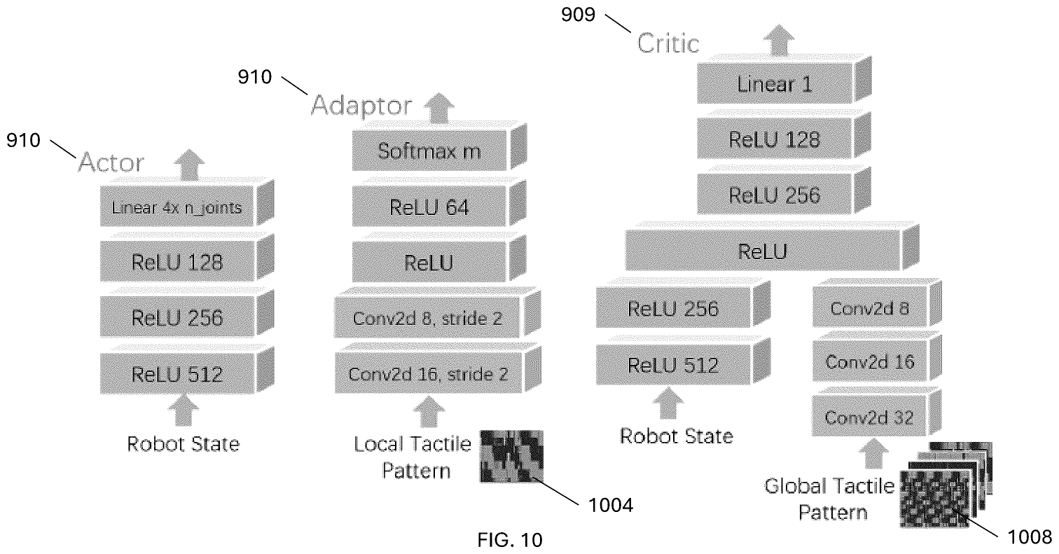

It can be observed that as the number of sensors increases, there is a noticeable decline in the simulator's efficiency, as manifested by the maximum real-time acceleration achievable by the simulator, denoted as the Real-Time Factor (RTF). As the bottleneck lies in the simulation side for large amounts of collision detection, a distributed RL framework deployable across multiple workstations was developed (FIG. 9). One or more of these workstations may serve as the server 904, with an agent 908 comprising a critic 909 and an actor 910 (gait library and adaptors), along with a centralized replay buffer 912 to store experiences. The other workstations 916n run multiple simulator instances (workers 920n), each instance containing only one agent 908 interacting with the environment. The experiences gained by the workers may be transmitted to the server via TCP/IP protocol, and agent training (on GPU) is exclusively conducted at the server end. The server 904 may periodically synchronize the actors 910 to each worker 920. In various embodiments, each adaptor 909 may only receive a local tactile pattern 1004 as described herein, recorded from a module 104 and its two adjacent modules, while the critic 909 receives the global tactile patterns 1008 from the plurality of tactile sensors 108 across the entire body. An exemplary neural network architecture implemented is schematically illustrated in FIG. 10.

### Experiments

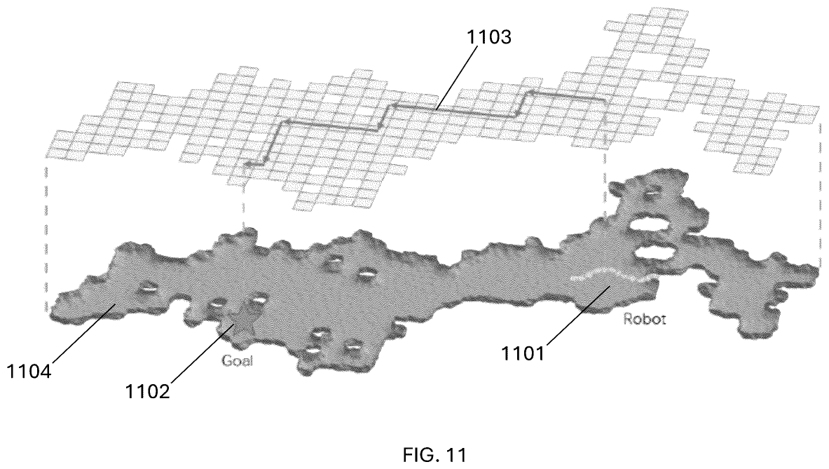

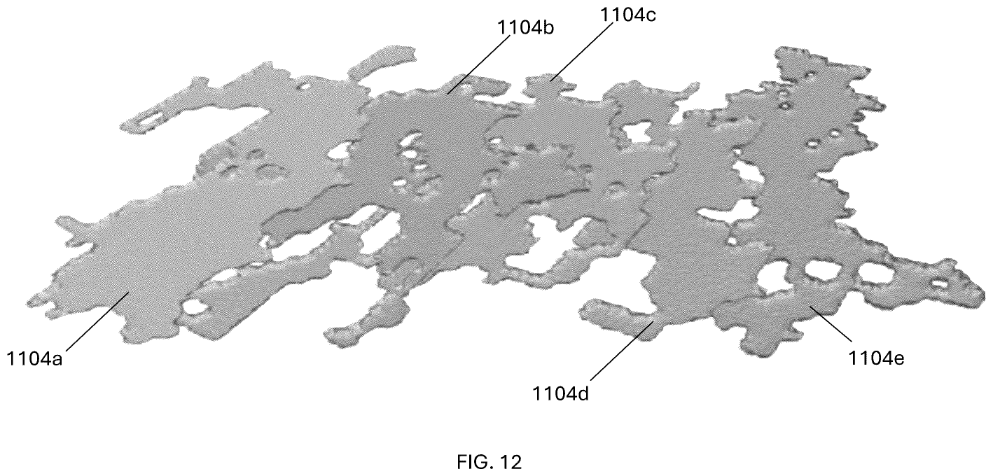

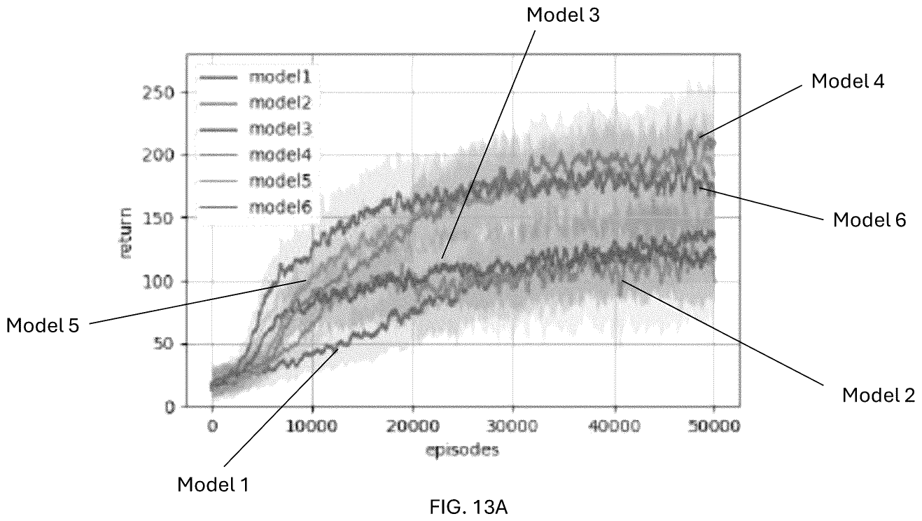

The terrain adaptability snake robot locomotion of the aforementioned methods may be tested in a randomly generated terrain 1104, such as a randomly generated cave 1104, as shown in FIG. 11. For example, and without limitation, the randomly generated terrain 1104 may have dimensions of 155 m×102 m. In this example, the uneven surface of the terrain of the cave may present a challenge for the snake robot 100 to move. The tasks involve autonomous navigation of the snake robot 100 from any initial position 1101 to any specified target point 1102, as described above. The cave may be divided into 4 m×4 m blocks, with the high-level controller planning a path 1103 based on the grid. In order to test generalizability of the herein disclosed methods, a plurality of test terrains 1104a-1104e may be implemented as shown in FIG. 12.

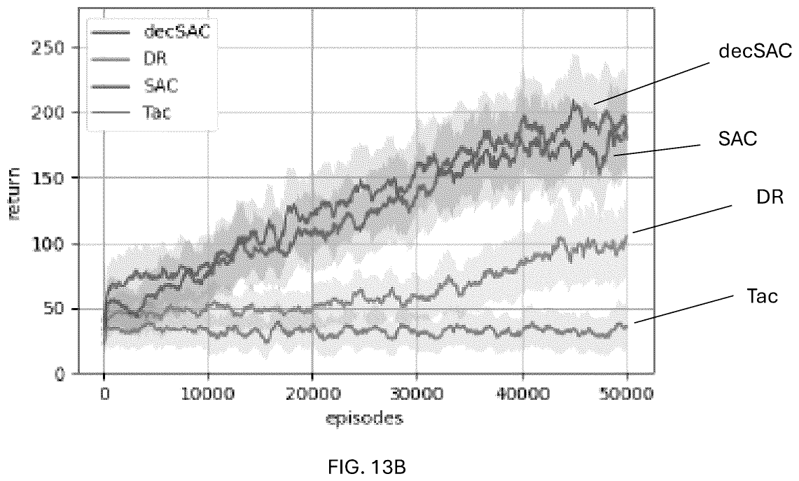

The training curves for the two phases of training described in FIG. 6 at steps 615 and 620 is illustrated in FIGS. 13A and 13B. The plot of FIG. 13A shows the results of six curriculum learning on different terrains, during which snake robot 100 learned basic gaits without tactile perception. Following the first phase, as shown in FIG. 13B, the results of terrain adaptation method (desSAC) trained on six terrains beyond the curriculum learning is shown. It can be observed that at the beginning of the second phase, due to change in terrains, the gaits learned in the first phase are not readily adaptable to the new environment (sudden drop compared with the end of plot of FIG. 13A). However, after training, the algorithm described herein demonstrated performance similar to curriculum learning on various new terrains. Additionally, it can be observed that there is little difference in the final performance between centralized and decentralized adaptors (SAC vs. desSAC), thus demonstrating the feasibility of training using MARL. For the method that does not use tractile information but relies solely on domain randomization (DR), it can be observed that learning has performance bottlenecks. Furthermore, it can be observed that directly incorporating tactile information as part of the state space (Tac) yields ineffective results, where all results are averaged from 10 independent trials. An analysis of terrain adaptability can be referenced in Table II, where M1-M6 represent the six models in the curriculum training, and T1-T6 corresponds to the matching training terrains for M1-M6. As observed, the diagonal shape in the table indicates that M1-M6 only perform well in their respective training scenarios but are hard to adapt to untrained environments. T7 and T8 are two entirely new test environments beyond the two training phases. It can be seen that neither M1-M6 nor DR can perform well in the new environments, whereas the approach described herein is capable of extracting terrain characteristics from tactile information and adopting adaptive gaits.

TABLE II
Model-terrain generalization analysis (return with standard deviation).

| | T1 | T2 | T3 | T4 | T5 | T6 | T7 | T8 |
|---|---|---|---|---|---|---|---|---|
| M1 | 227.8 ± | 75.3 ± | 59.5 ± | 90.6 ± | 94.2 ± | 76.4 ± | 103.2 ± | 88.1 ± |
| | 6.1 | 7.3 | 5.6 | 9.0 | 5.8 | 4.6 | 4.6 | 4.6 |
| M2 | 124.9 ± | 206.3 ± | 78.5 ± | 84.5 ± | 101.2 ± | 82.8 ± | 62.5 ± | 77.8 ± |
| | 7.6 | 3.8 | 6.7 | 4.0 | 6.4 | 8.8 | 6.4 | 6.4 |
| M3 | 139.4 ± | 64.3 ± | 163.0 ± | 103.2 ± | 96.3 ± | 70.4 ± | 90.3 ± | 82.8 ± |
| | 4.1 | 5.5 | 5.4 | 7.2 | 6.7 | 4.4 | 4.4 | 4.4 |
| M4 | 108.6 ± | 98.7 ± | 59.8 ± | 153.0 ± | 82.4 ± | 96.4 ± | 83.1 ± | 101.0 ± |
| | 5.7 | 8.4 | 7.7 | 4.0 | 6.4 | 5.5 | 5.5 | 5.5 |
| M5 | 72.8 ± | 76.5 ± | 40.1 ± | 78.4 ± | 159.1 ± | 85.1 ± | 43.8 ± | 56.6 ± |
| | 6.3 | 4.5 | 7.2 | 4.9 | 7.0 | 8.5 | 8.5 | 8.5 |
| M6 | 96.3 ± | 83.6 ± | 67.4 ± | 96.7 ± | 71.4 ± | 154.8 ± | 72.3 ± | 89.2 ± |
| | 4.3 | 6.5 | 7.0 | 6.2 | 5.9 | 4.1 | 5.9 | 5.9 |
| DR | 116.3 ± | 102.9 ± | 73.4 ± | 120.2 ± | 107.5 ± | 140.3 ± | 98.9 ± | 158.2 ± |
| | 7.2 | 10.3 | 6.4 | 8.2 | 4.6 | 5.3 | 7.0 | 7.1 |
| Ours | 210.5 ± | 230.8 ± | 101.6 ± | 172.6 ± | 169.8 ± | 152.2 ± | 127.4 ± | 235.0 ± |
| | 13.3 | 8.7 | 8.5 | 6.7 | 9.9 | 4.6 | 6.7 | 8.8 |

### Cave Navigation Performance

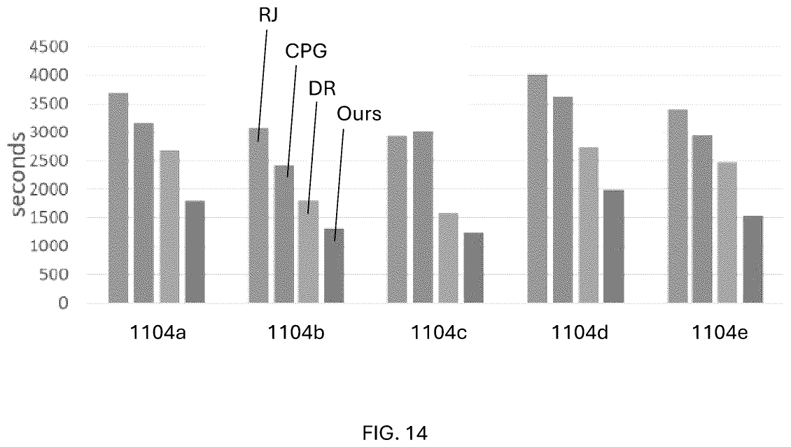

The results of several baselines in navigating the five terrains 1104a-1104e shown in FIG. 12 using RL may be compared and the comparison of runtime as shown in FIG. 14. The action space of method “RJ” may be robot's target joint angles, while the action space “CPG” may consist of parameters for the CPG modules. The “DR” method introduces the Domain Randomization on top of CPG. The baselines in FIG. 14 did not use tactile information. It can be observed that the method implemented according to the herein teachings achieved the most efficient navigation results. Similar to the Tac results shown in FIG. 13B, directly incorporating tactile information into the state spaced, regardless of RJ, CPG, or DR in the action space, failed to complete the navigation tasks within a reasonable timeframe, and therefore, the results are not depicted in FIG. 14. The reason for this may be the inherent difficulty of simultaneously learning both gait and terrain adaptability from scratch, in contrast to the disclosed methods herein, wherein the training is divided into two phases, each focusing on learning gait and terrain adaptability, respectively. This approach thereby simplifies the problem by decoupling the two tasks.

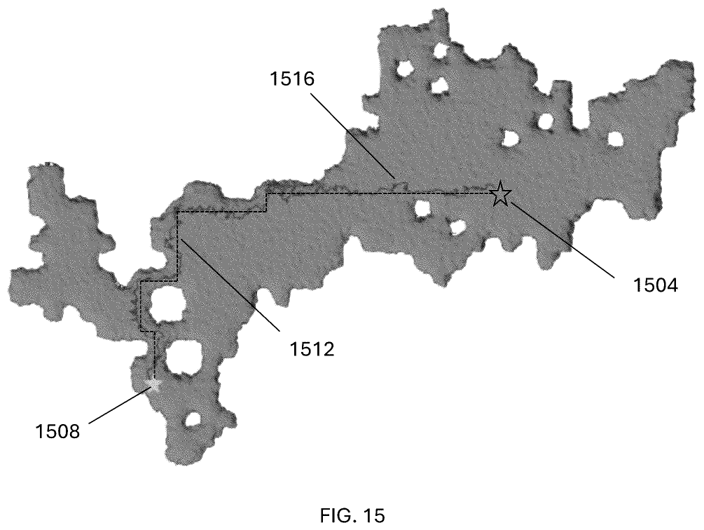

Referring now to FIG. 15, the centroid motion trajectory 1516 of snake robot 100 from a start portion 1504 to a goal position 1508 in one of the test terrains shown in FIG. 12 is shown. It can be observed that the centroid motion trajectory 1516 closely aligns with the path 1512 planned by the high-level controller. By observing the robot's motion at a closer distance, it can be seen that when tactile information is not utilized, i.e., RL directly determines the parameters of the CPG module base on the robot's state, the terrain adaptability is compromised.

This shows that the hierarchical reinforcement learning control scheme as described above to address the navigation problem of snake robots equipped with whole-body tactile perception in complex terrains, incorporating tactile information, snake robots can perceive environmental characteristics and adjust their gaits accordingly to achieve terrain adaptability. Validation experiments across various terrains demonstrated superior performance of this control and learning methodology compared to traditional RL solutions.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A method for snake robot navigation, the method comprising:
providing a snake robot comprising a plurality of modules and a plurality of tactile sensors disposed thereon;
planning a path over a terrain between an initial position and a target location;
detecting a tactile datum from the plurality of tactile sensors;
selecting, based on the path, one of a plurality of gaits the snake robot may perform by relative movement of the plurality of modules;
dynamically adjusting the selected gait based on the tactile datum; and
commanding the plurality of modules to perform the adjusted gait.

2. The method of claim 1, wherein planning the path comprises segmenting the path over terrain into a series of contiguous waypoints between the initial position and the target location.

3. The method of claim 2, wherein planning the path over the terrain is performed by a high-level controller of a hierarchical reinforcement learning model.

4. The method of claim 3, wherein selecting the gait and dynamically adjusting the selected gait is performed by a low-level controller of the hierarchical reinforcement learning model.

5. The method of claim 1, wherein dynamically adjusting the selected distinct gait comprises training an adaptor to recognize a terrain feature from the tactile datum, thereby selecting an adjusted gait to traverse the at least one terrain feature along the path.

6. The method of claim 1, wherein detecting the tactile datum from the plurality of tactile sensors comprises detecting tactile data corresponding to a subset of the plurality of modules.

7. The method of claim 6, wherein the subset of the plurality of modules is a module and its two adjacent modules.

8. The method of claim 6, wherein commanding the plurality of modules to perform the adjusted gait comprises commanding the subset of the plurality of modules based on the tactile data from the respective modules.

9. The method of claim 1, wherein commanding the plurality of modules to perform the adjusted gait comprises commanding a first subset of the plurality of modules to rotate in a first plane and a second subset of the plurality of modules to rotate in a second plane.

10. The method of claim 9, wherein the first plane is orthogonal to the second plane.

11. The method of claim 1, wherein the plurality of gaits comprises sidewinding, tumbling, lateral rolling, helical rolling, c-pedal wave, crawling and undulating.

12. The method of claim 1, wherein the tactile datum comprises a contact pattern between the plurality of modules and the terrain.

13. The method of claim 1, wherein the at least one tactile datum comprises:
a local contact pattern between a subset of the plurality of modules and the terrain; and
a global contact pattern between the plurality of modules and the terrain.

14. The method of claim 1, wherein the tactile datum comprises at least one of surface roughness and slope.

15. The method of claim 1, wherein planning a path between the initial position and the target location comprises performing a tree search of a plurality of possible paths between the initial position and the target location.

16. The method of claim 1, further comprising processing sequences of tactile sensor data to determine changes in terrain characteristics over time.

17. The method of claim 16, wherein dynamically adjusting the selected gait comprises adjusting the selected gait in response to the detected change in terrain characteristics.

18. A method for training a snake robot, the method comprising:
providing a snake robot having a plurality of modules and a plurality of tactile sensors;
providing a path from a starting position to a target position for the snake robot to traverse;
generating in a first phase of training, a gait library comprising a plurality of gaits executable by the plurality of modules of the snake robot to traverse the path;
generating in a second phase of training, a respective adaptor for each module configured to receive a tactile datum from the plurality of tactile sensors;
adjusting the gaits based on the tactile datum received by the adaptor; and
commanding the plurality of modules to execute the adjusted gait.

19. The method of claim 18, wherein the first and second phases of training are performed by a hierarchical reinforcement learning model.

20. The method of claim 19, wherein the hierarchical reinforcement learning model comprises a high-level controller for global navigation and a low-level controller for local navigation.
